(19) United States
(12) Patent Application Publication
(10) Pub. No.: US 2020/0108353 A1
(43) Pub. Date: Apr. 9, 2020

(54) GRAPHENE OXIDE MEMBRANES FOR FILTERING ORGANIC SOLUTIONS

(71) Applicant: The University of Manchester, Manchester (GB)

(72) Inventors: Rahul Raveendran Nair, Manchester (GB); Su Yang, Manchester (GB)

(21) Appl. No.: 16/498,341

(22) PCT Filed: Mar. 29, 2018
(86) PCT No.: PCT/GB2018/050862

§ 371 Date: Sep. 26, 2019

(30) Foreign Application Priority Data
Mar. 29, 2017 (GB) 1705030.3

(51) Int. Cl. B01D 71/02; B01D 69/06; B01D 61/02

(52) U.S. Cl. CPC B01D 71/021; B01D 71/024; B01D 2325/04; B01D 61/027; B01D 69/06

(57) ABSTRACT

This invention relates to membranes that can be used to remove solutes from organic solutions. The invention also relates to methods of using said membranes and the use of said membranes to filter organic solutions. The membranes are thin graphene oxide (GO) laminate membranes.

This invention relates to membranes that can be used to remove solutes from organic solutions. The invention also relates to methods of using said membranes and the use of said membranes to filter organic solutions. The membranes are thin graphene oxide (GO) laminate membranes.

### BACKGROUND

In the field of organic synthesis, and particularly the large scale production of pharmaceuticals, it is frequently necessary to remove organic solvents from organic products (either the desired final product of the synthesis or synthetic intermediates formed during the synthesis) which are dissolved in those solvents. Typically this is achieved using distillation techniques that require both heat and application of a vacuum. Such techniques are high in energy consumption.

An alternative method of removing solvents from organic solutes is organic solvent nanofiltration (OSN), the passing of the solution through a membrane through which the solvent passes but through which the organic products do not pass. Commercial nanofiltration membranes are polymeric in Vandezande et al; Chem Soc Rev. 2008, 37, 365-405; Marchetti et al; Chem. Rev., 2014, 11. Such membranes can become eroded when exposed to organic solvents, giving them short effective lifetimes. Commercial polymeric membranes tend also to provide a rejection for the organic product that is less than 100%, lowering yields and thus the efficiency of the synthesis. Solvent fluxes can also be low.

Graphene oxide laminate membranes having thicknesses greater than 100 nm have been shown to allow the passage of water but to exclude solutes and particularly any solute having a hydration radius greater than 4.5 Å (see WO2015/075451). Organic solvents do not pass through such membranes.

It is an aim of certain embodiments of this invention to provide new membranes and methods of using said membranes that are useful for nanofiltration of organic solutions. It is an aim of certain embodiments of this invention to provide new membranes and methods of using said membranes that offer improved chemical stability and/or greater longevity than prior art membranes. It is an aim of certain embodiments of this invention to provide new membranes and methods of using said membranes that exclude a larger amount of product than prior art membranes. It is an aim of certain embodiments of this invention to provide new membranes and methods of using said membranes that offer higher solvent flux than prior art membranes.

### BRIEF SUMMARY OF THE DISCLOSURE

In a first aspect of the present invention there is provided a graphene oxide laminate membrane;

wherein the laminate membrane comprises a plurality of graphene oxide flakes having a size distribution such that greater than 75% of the flakes have a shortest lateral dimension that is greater than 3 μm; and

wherein the graphene oxide laminate membrane is no more than 80 nm thick.

In a second aspect of the present invention there is provided a method of reducing the amount of at least one solute in an organic solution to produce a product solution depleted in said solute or solutes; the method comprising:
(a) contacting a first face of a graphene oxide laminate membrane with the organic solution comprising the solute or solutes; and
(b) recovering the product solution from or downstream from a second face of the membrane and/or recovering the residue comprising the excluded solute or solutes from or downstream from the first face of the membrane;
   wherein the graphene oxide laminate membrane is no more than 80 nm thick; and wherein the laminate membrane comprises a plurality of graphene oxide flakes.

In a third aspect of the present invention there is provided a use of a graphene oxide laminate membrane to reduce the amount of at least one solute in an organic solution;

wherein the graphene oxide laminate membrane is no more than 80 nm thick; and

wherein the laminate membrane comprises a plurality of graphene oxide flakes.

The inventors have found that graphene oxide laminate membranes that are less than 80 nm thick allow the passage of organic solvents and can be used to remove solutes dissolved in them. It had previously been found that organic solvents do not pass through graphene oxide laminate membranes. Those membranes were thicker than 80 nm. Where the graphene oxide laminate membrane is thicker than 80 nm, organic solvents cannot permeate the membrane to a detectable level.

In a fourth aspect of the present invention there is provided a graphene oxide laminate membrane;

wherein the laminate membrane comprises a plurality of graphene oxide flakes and, intercalated between the graphene oxide flakes, a plurality of metal cations;

wherein the graphene oxide laminate membrane is no more than 5 μm thick.

In a fifth aspect of the present invention there is provided a method of reducing the amount of at least one solute in an organic solution to produce a product solution depleted in said solute or solutes; the method comprising:
(a) contacting a first face of a graphene oxide laminate membrane with the organic solution comprising the solute or solutes; and
(b) recovering the product solution from or downstream from a second face of the membrane and/or recovering the residue comprising the solute or solutes from or downstream from the first face of the membrane;

wherein the laminate membrane comprises a plurality of graphene oxide flakes and, intercalated between the graphene oxide flakes, a plurality of metal cations.

The graphene oxide laminate membrane may be no more than 5 μm thick.

In a sixth aspect of the present invention there is provided a use of a graphene oxide laminate membrane to reduce the amount of at least one solute in an organic solution;

wherein the laminate membrane comprises a plurality of graphene oxide flakes and, intercalated between the graphene oxide flakes, a plurality of metal cations.

The graphene oxide laminate membrane may be no more than 5 μm thick.

The inventors have also found that thin graphene oxide membranes having metal cations intercalated between the flakes can be used to remove solutes having a radius radius of hydration above about 4.5 Å from organic solvents.

### Laminate Membranes

The present invention is directed to and involves the use of graphene oxide laminate membranes. The graphene oxide laminate membranes of the invention comprise overlapped layers of substantially parallel individual graphene oxide flakes. Other than being substantially parallel, the flakes are randomly orientated. The flakes are predominantly monolayer graphene oxide. The laminate membranes of the invention have the overall shape of a sheet-like material through which liquid may pass when the laminate is wet. The laminate membrane can be used as a filtration membrane. Without wishing to be bound by theory, the liquid is not understood to pass through the flakes. It is believed that the individual flakes are stacked in such a way as to form capillary-like pathways between the faces and sides of the flakes and it is through these pathways that the liquid passes.

Although the flakes are predominantly monolayer graphene oxide, it is within the scope of this invention that some of the graphene oxide is present as two- or few-layer graphene oxide. Thus, it may be that at least 75% by weight of the graphene oxide is in the form of monolayer graphene oxide flakes, or it may be that at least 85% by weight of the graphene oxide is in the form of monolayer graphene oxide flakes (e.g. at least 95%, for example at least 99% by weight of the graphene oxide is in the form of monolayer graphene oxide flakes) with the remainder made up of two- or few-layer graphene oxide.

The graphene oxide laminate membranes of the first, second and third aspects of the invention are not more than 80 nm thick. It may be that the graphene oxide laminate membranes are not more than 70 nm thick. It may be that the graphene oxide laminate membranes are not less than 5 nm thick. It may be that the graphene oxide laminate membranes are not less than 8 nm thick. The graphene oxide laminate membranes may be from 8 nm to 20 nm thick. The graphene oxide laminate membranes may be from 8 nm to 15 nm thick. The graphene oxide laminate membranes may be from 5 nm to 20 nm thick. The graphene oxide laminate membranes may be from 5 nm to 15 nm thick.

Graphene oxide flakes are two dimensional heterogeneous macromolecules containing both hydrophobic ‘graphene’ regions and hydrophilic regions with large amounts of oxygen functionality (e.g. epoxide, carboxylate groups, carbonyl groups, hydroxyl groups).

It may be that the graphene oxide flakes of which the laminate is comprised have an oxygen:carbon weight ratio in the range of from 0.02:1.0 to 0.5:1.0. The flakes may be graphene oxide flakes, in which case the average oxygen:carbon weight ratio may be in the range of from 0.2:1.0 to 0.5:1.0, e.g. from 0.25:1.0 to 0.45:1.0. Preferably, the flakes have an average oxygen:carbon weight ratio in the range of from 0.3:1.0 to 0.4:1.0. The flakes may be partially reduced graphene oxide flakes, in which case the average oxygen:carbon weight ratio may be in the range of from 0.04:1.0 to 0.2:1.0, e.g. from 0.05:1.0 to 0.1:1.0. Graphene oxide flakes may be preferred if a higher flux is desired. Partially reduced graphene oxide flakes may be preferred if a better membrane stability is desired.

The laminate membrane is typically comprised in a composite with a porous support. Thus, it may be that the graphene oxide laminate membrane is supported on a porous material. This can provide structural integrity. In other words, the graphene oxide flakes may themselves form a layer, e.g. a layer that is itself a laminate, which itself is associated with a porous support such as a porous membrane to form a further laminate structure, each layer of the further laminate structure being either the porous material or the graphene oxide laminate membrane. It may be that the graphene oxide laminate membrane is supported on a layer of a porous material. It may be that the graphene oxide laminate membrane is sandwiched between layers of a porous material.

The porous support may be a woven material or it may be a porous membrane.

It may be that, if present, the porous material is an inorganic material. Thus, the porous material (e.g. membrane) may comprise a ceramic. Preferably, the material is alumina, zeolite, or silica. In one embodiment, the material is alumina. Zeolite A can also be used. Ceramic membranes have also been produced in which the active layer is amorphous titania or silica produced by a sol-gel process.

It may be that, if present, the porous material is a polymeric material. The polymeric material should be stable to the organic solvent in the organic solution that is being filtered. Thus, the porous material may thus be a porous polymer support, e.g. a flexible porous polymer support. The membrane may be Nylon, PES, PTFE, PVDF or Cyclopore™ polycarbonate. The porous material (e.g. membrane) may comprise a polymer. The polymer may comprise a synthetic polymer. These can be used in the invention. Alternatively, the polymer may comprise a natural polymer or modified natural polymer. Thus, the polymer may comprise a polymer based on cellulose. The polymer support may be derived from a charged polymer such as one which contains sulfonic acids or other ionisable functional groups.

It may be that, if present, the porous material comprises a carbon monolith.

It may be that, if present, the porous support layer has a thickness of no more than a few tens of μm, and may be less than about 1 mm thick or even less than about 100 μm. Preferably, it has a thickness of 50 μm or less, more preferably of 10 μm or less. In some cases it may be less than about 1 μm thick though preferably it is more than about 1 μm.

The porous support should be porous enough not to interfere with water transport but have small enough pores that graphene oxide platelets cannot enter the pores. Thus, the porous support must be water permeable. In an embodiment, the pore size is less than 1 μm, e.g. less than 500 nm or less than 200 nm. Typically the pore size will be greater than 1 nm, e.g. greater than 10 nm.

The porous material may have a uniform pore-structure. Examples of porous membranes with a uniform pore structure are electrochemically manufactured alumina membranes (e.g. those with the trade names: Anopore™, Anodisc™).

The porous support could take the form of a flat sheet. Alternatively, it could take the form of a tube, with the GO laminate membrane coated on either the inside or the outside surface of the tube.

It may be that the laminate membrane comprises a plurality of graphene oxide flakes having a size distribution such that greater than 75 wt % (e.g. greater than 85% or greater than 95%) of the flakes have a shortest lateral dimension that is greater than 1 μm. It may be that the laminate membrane comprises a plurality of graphene oxide flakes having a size distribution such that greater than 75 wt % (e.g. greater than 85% or greater than 95%) of the flakes have a shortest lateral dimension that is greater than 2 μm. It may be that the laminate membrane comprises a plurality of graphene oxide flakes having a size distribution such that greater than 75 wt % (e.g. greater than 85% or greater than 95%) of the flakes have a shortest lateral dimension that is greater than 8 μm. It may be that the laminate membrane comprises a plurality of graphene oxide flakes having a size distribution such that greater than 75 wt % (e.g. greater than 85% or greater than 95%) of the flakes have a shortest lateral dimension that is 10 μm or greater.

It has been found that laminate membranes comprised substantially of larger graphene oxide flakes, e.g. those having a shortest lateral distance that is greater than 3 μm, provide better rejection of solutes relative to those comprised substantially of smaller flakes. Without wishing to be bound by theory, it is believed that larger flakes form more homogeneous laminate structures and that this leads to fewer defects. This effect is not observed on thicker membranes such as those used in the prior art, in which the size of the graphene oxides flake is considered to have no significant effect on the performance of the membrane.

For partially reduced graphene oxide flakes, it may be that smaller flakes are tolerated, depending on the desired properties of the membrane. Thus, where the graphene oxide fakes are reduced graphene oxide flakes, it may be that the laminate membrane comprises a plurality of graphene oxide flakes having a size distribution such that greater than 75 wt % (e.g. greater than 85% or greater than 95%) of the flakes have a shortest lateral dimension that is greater than 200 nm.

It may be that the laminate membrane comprises a plurality of graphene oxide flakes having a size distribution such that greater than 75 wt % (e.g. greater than 85% or greater than 95%) of the flakes have a longest lateral dimension that is less than 100 μm. It may be that the laminate membrane comprises a plurality of graphene oxide flakes having a size distribution such that greater than 75 wt % (e.g. greater than 85% or greater than 95%) of the flakes have a longest lateral dimension that is less than 50 μm. It may be that the laminate membrane comprises a plurality of graphene oxide flakes having a size distribution such that greater than 75 wt % (e.g. greater than 85% or greater than 95%) of the flakes have a longest lateral dimension that is less than 25 μm. It may be that the laminate membrane comprises a plurality of graphene oxide flakes having a size distribution such that greater than 75 wt % (e.g. greater than 85% or greater than 95%) of the flakes have a longest lateral dimension that is 20 μm or less.

It may be that the full width of half maximum of the X-ray diffraction peak for the interlayer spacing is between 0.1 and 2 degree. This is diagnostic of a higher level of homogeneity in the laminate structure. Increased homogeneity of the graphene oxide laminate membrane, as mentioned above, can lead to improved rejection relative to less homogeneous membranes. This effect is not observed on thicker membranes.

The graphene oxide laminate may comprise at least 75% by weight graphene oxide. The graphene oxide laminate may comprise at least 90% by weight graphene oxide. The graphene oxide laminate may comprise at least 95% by weight graphene oxide. The graphene oxide laminate may comprise at least 99% by weight graphene oxide. The graphene oxide laminate membrane may comprise only graphene oxide.

Alternatively, the graphene oxide laminate membranes may comprise a crosslinking agent.

The graphene oxide laminate membrane may comprise a polymer as a crosslinking agent. The polymer should be stable to the organic solvent in the organic solution being filtered. The polymer may be interspersed throughout the membrane. It may occupy the spaces between the individual flakes, thus providing interlayer crosslinking. The polymer may be polyvinylalcohol or polyvinylacetate. Other polymers which could be used in this manner include poly(4-styrenesulfonate), Nafion, carboxymethyl cellulose, Chitosan, polyvinyl pyrrolidone, polyaniline etc. It may be that the polymer is water soluble. Alternatively, it may be that the polymer is not water soluble.

Where the laminate membrane comprises a polymer, that polymer may be present in an amount from about 0.1 to about 50 wt %, e.g. from about 0.2 to about 25 wt %. Thus, the laminate membrane may comprise from about 1 wt % to about 15 wt % polymer. The laminate membrane may comprise no more than 10 wt % polymer.

It may be that the graphene oxide laminate membrane does not comprise a polymer.

The laminate membrane may comprise, intercalated between the graphene oxide flakes, a plurality of metal cations. Without wishing to be bound by theory, such a laminate membrane has substantially the same randomly ordered layered structure as a laminate membrane that does not comprise metal ions but the structure is disrupted by the metal ions. Such membranes can offer increased flux relative to the equivalent membranes without intercalated cations but lower rejection rates. The metal cations are typically bonded to the oxidized regions of the graphene oxide flakes by ionic bonds or by chelation. Cation crosslinking is typically introduced into the graphene oxide when it is a dispersion, before preparing the membrane. Non-temporary bonding between graphene oxide flakes and metal cations cannot easily be formed once the membrane has been formed.

Laminate membranes with intercalated metal ions tolerate greater thicknesses before solvent flux becomes so low as to be impractical. Thus, the intercalated laminate membrane may be no more than 30 μm thick. It may be that the intercalated graphene oxide laminate membrane is not more than 20 μm thick. It may be that the intercalated graphene oxide laminate membrane is not more than 5 μm thick. It may be that the intercalated graphene oxide laminate membrane is not more than 1 μm thick. It may be that the intercalated graphene oxide laminate membrane is not less than 500 nm thick. The intercalated graphene oxide laminate membrane may be from 5 nm to 1 μm thick. The intercalated graphene oxide laminate membrane may be from 8 nm to 1 μm thick. The graphene oxide laminate membrane may be from 100 nm to 500 nm thick.

Laminate membranes with intercalated metal ions tolerate smaller flakes size before solvent permeability becomes impractical. Thus, it may be that the intercalated laminate membrane comprises a plurality of graphene oxide flakes having a size distribution such that greater than 75 wt % (e.g. greater than 85% or greater than 95%) of the flakes have a shortest lateral dimension that is greater than 50 nm. It may be that the intercalated laminate membrane comprises a plurality of graphene oxide flakes having a size distribution such that greater than 75 wt % (e.g. greater than 85% or greater than 95%) of the flakes have a shortest lateral dimension that is greater than 100 nm. It may be that the intercalated laminate membrane comprises a plurality of graphene oxide flakes having a size distribution such that greater than 75 wt % (e.g. greater than 85% or greater than 95%) of the flakes have a shortest lateral dimension that is less than 10 μm. It may be that the intercalated laminate membrane comprises a plurality of graphene oxide flakes having a size distribution such that greater than 75 wt % (e.g. greater than 85% or greater than 95%) of the flakes have a shortest lateral dimension that is 1 μm or greater. It may be that the intercalated laminate membrane comprises a plurality of graphene oxide flakes having a size distribution such that greater than 75 wt % (e.g. greater than 85% or greater than 95%) of the flakes have a shortest lateral dimension that is 500 nm or less. It may be that the intercalated laminate membrane comprises a plurality of graphene oxide flakes having a size distribution such that greater than 75 wt % (e.g. greater than 85% or greater than 95%) of the flakes have a shortest lateral dimension that is 250 nm or less.

The laminate membrane with intercalated metal ions may be comprised of partially reduced graphene oxide flakes such as those described above. In this system, a membrane comprised of partially reduced graphene oxide flakes typically provides better rejection rates than membrane comprised of non-reduced graphene oxide flakes.

The metal cations may be cations of elements selected from s-block metals, d-block-metals, p-block metals and f-block metals. The cations may be selected from Li⁺, Na⁺, K⁺, Mg²⁺, Ca²⁺, Zn²⁺, La³⁺, Sn⁴⁺, etc. The metal cations may be cations having a charge greater than or equal to 2+. The cations may be selected from Mg²⁺ or Zn²⁺. The cations may be Mg²⁺ ions.

The cations may be present in an amount from 0.06 wt % to 0.6 wt % of the graphene oxide flakes. The cations may be present in an amount from 0.06 wt % to 0.6 wt % of the graphene oxide flakes. The cations may be present in an amount from 0.06 wt % to 0.6 wt % of the graphene oxide flakes.

The graphene oxide laminate membrane may comprise other two dimensional materials, e.g. graphene, reduced graphene oxide, clays, silicene, transition metal dichalcogenides, etc.

The graphene oxide laminate membrane may comprise other inorganic materials. Said inorganic materials may include materials such as alumina, silica, titanium oxide, etc.

The graphene oxide laminate membrane may be comprised in a liquid filtration device. The liquid filtration device may be a filter or it may be a removable and replaceable filter unit for a filtration apparatus. The filtration device may be a filtration apparatus.

The graphene oxide laminate membranes are particularly useful for the nanofiltration of organic solutions, e.g. in the methods of the second and fifth aspects of the invention or the uses of the third and sixth aspects of the invention. They may also be used for the nanofiltration of aqueous solutions. For aqueous applications they offer the benefit of increased flux relative to thicker membranes.

### Methods and Uses

An ‘organic solution’ is a solution of at least one solute in an organic solvent.

The term “solute” applies to both ions and counter-ions, and to uncharged molecular species present in the solution. Once dissolved in a solvent a salt forms solutes comprising solvated ions and solvated counter-ions. Uncharged molecular species can be referred to as “non-ionic species”. Examples of non-ionic species are small organic molecules such as aliphatic or aromatic hydrocarbons (e.g. toluene, benzene, hexane, etc), alcohols (e.g. methanol, ethanol, propanol, glycerol, etc), carbohydrates (e.g. sugars such as sucrose), and amino acids and peptides. Examples of other organic species include aldehydes, cyanates, isocyanates, halohydrocarbons, ketones, amines, amides, ethers, esters, aromatic compounds, heteroaromatic compounds etc. The non-ionic species may or may not hydrogen bond with water. Certain non-ionic species form ions when dissolved in certain solvents, and such ionic species are also considered to fall within the term ‘solute’. Likewise zwitterionic species are considered to fall within the term ‘solute’. As will be readily apparent to the person skilled in the art, the term ‘solute’ does not encompass solid substances which are not dissolved in the organic solvent. Particulate matter would not be expected to pass through the membranes of the invention even if the particulate is comprised of ions with small radii.

The term “hydration radius” refers to the effective radius of the molecule or ion when solvated in aqueous media.

The reduction of the amount solute or solutes in the solution which is treated with the laminate membrane of the present invention may entail entire removal of the selected solute or of each selected solute. Alternatively, the reduction may not entail complete removal of any individual solute but simply a lowering of its concentration. The reduction may result in an altered ratio of the concentration of any solute or solutes relative to the concentration of another solute or other solutes.

The term ‘organic solvent’ refers to any solvent or mixture of solvents which comprises no more than 10% water by weight, e.g. less than 10% water by weight. The bulk of the weight of the organic liquid (up to 75%, e.g. up to 90% or up to 99.9%) will be an organic solvent or mixture of organic solvents. It may comprise no more than 5% water by weight, e.g. no more than 2% water by weight or no more than 1% water by weight. The organic solvents in a mixture may be wholly or partially miscible or they may be immiscible. Typically the mixture will be a mixture of miscible organic solvents in which the solute or solutes are dissolved. This does not exclude the possibility that there might be particulate matter, droplets or micelles suspended in the solution. Of course, it is expected that particulate matter will not pass through the membranes of the invention even if it is comprised of ions or molecules with small radii.

Exemplary organic solvents include: alcohols (e.g. methanol, ethanol, isopropanol, 1-butanol, tert-butanol, ethylene glycol); hydrocarbons (e.g. hexane, pentane, heptane, cyclohexane), ethers (e.g. dimethylethylene glycol, diethyl ether, t-butylmethyl ether, tetrahydrofuran, dioxane); ketones (e.g. acetone, t-butylmethylketone), amides (e.g. N-methylpyrrolidine, dimethylformamide, dimethylacetamide), sulfoxides (e.g. dimethylsulfoxide), aromatic solvents (e.g. benzene, toluene), esters (e.g. ethyl acetate or butyl acetate), nitriles (e.g. acetonitrile), chlorinated solvents (e.g. chloroform, dichloromethane, 1,2-dichloroethane) and mixture thereof.

The solution contacts a first face of the membrane and purified (either wholly or partially purified) solvent is recovered from the other face or side of the membrane. Additionally or alternatively, the residues, comprising the excluded solute or solutes, may be recovered from the first face of the membrane.

It may be that the method is continuous. Thus, steps (a) and (b) may be carried out simultaneously or substantially simultaneously.

It may be that the organic solution is permitted to pass though the membrane through diffusion and/or it may be that a pressure is applied and/or the liquid passes through the membrane through force of gravity.

The method may involve a plurality of graphene oxide laminate membranes. Thus, the filtration device may comprise a plurality of graphene oxide laminate membranes. These may be arranged in parallel (to increase the flux capacity of the process/device) or in series (where a reduction in the amount of one or more solute is achieved by a single laminate membrane but that reduction is less than desired).

The concentration of the excluded solute or solutes in the product organic solution may be reduced by 25% or more relative to the concentration in the starting organic solution. The concentration of the excluded solute or solutes in the product organic solution may be reduced by 50% or more relative to the concentration in the starting organic solution. The concentration of the excluded solute or solutes in the product organic solution may be reduced by 80% or more relative to the concentration in the starting organic solution. The concentration of the excluded solute or solutes in the product organic solution may be reduced by 90% or more relative to the concentration in the starting organic solution. The concentration of the excluded solute or solutes in the product organic solution may be reduced by 95% or more relative to the concentration in the starting organic solution. The excluded solute or solutes referred to in this specification are those that are present in lower concentration in the product organic solution than they were in the starting organic solution.

Typically, the excluded solute or solutes have a hydration radius greater than 4.5 Å. The excluded solute or solutes may have a hydration radius greater than 4.75 Å. The excluded solute or solutes may have a hydration radius greater than 5 Å.

The method may involve the recovery of the residue comprising the excluded solute or solutes from the first face of the membrane. This is particularly the case where it is desired to obtain the solute or solutes that have been excluded by the membrane. The residue will usually contain the solutes which may be, for example, either the desired product of or an intermediate in the synthetic process. The residue may be an oil or a solid consisting substantially of the excluded solute or solutes. The residue may be a solution of the excluded solute or solutes in the organic solvent, the concentration of said excluded solute or solutes in said solution being higher than the concentration of the excluded solute or solutes in the starting organic solution.

It may that any remaining organic solvent is removed from said excluded solute or solutes, e.g. by distillation under vacuum or by passing a stream of a gas over the product and/or heating the product.

### BRIEF DESCRIPTION OF THE DRAWINGS

Embodiments of the invention are further described hereinafter with reference to the accompanying drawings, in which:

FIG. 1 shows images of an ultrathin HLGO membrane. (a) SEM image of an 8 nm thick HLGO membrane on an Anodisc alumina support. Scale bar, 1 μm. Inset: SEM image of bare alumina support. Scale bar, 500 nm. (b) X-ray diffraction for HLGO and CGO membranes. Inset (left): AFM image of HLGO membrane transferred from an alumina substrate to a silicon wafer. Scale bar, 500 nm. Inset (right): The height profiles along the dotted rectangle.

FIG. 2 shows some molecular sieving and organic solution nanofiltration experiments through HLGO membranes. (a) Experiments for salt rejection as a function of ion's hydrated radius (largest ions within the aqueous solutions are plotted). The HLGO membranes is 8 nm thick. MB—Methylene Blue, RB—Rose Bengal, BB—Brilliant Blue. (b) Permeance of pure organic solvents through an 8 nm HLGO membrane as a function of their inverse viscosity. The used solvents are numbered and named on the right. Inset (top): Methanol permeance as a function of pressure gradient (ΔP). Dotted lines: Best linear fits. (c) Rejection (represented by empty squares) and permeance (represented by diamonds) of several dyes in methanol versus their molecular weight. The dyes used: Chrysoidine G (CG), Disperse Red (DR), MB, Crystal Violet (CV), BB and RB. Left inset: Photographs of dyes dissolved in methanol before and after filtration through 8 nm HLGO membranes. Right inset: MB rejection (bars in black for each respective thickness) and methanol permeance (hashed bars for each respective thickness) of CGO membrane with different thicknesses. All the error bars are standard deviations. Points between the two hashed parallel lines in FIGS. 1a and c show the rejection estimated from the detection limit (FIG. 5 and Methods section below).

FIG. 3 shows further experiments probing molecular permeation through HLGO membranes. (a) X-ray diffraction for 70 nm thick HLGO membranes immersed in various organic solvents. (b) Thickness dependence of permeance for methanol (represented by grey triangles), hexane (represented by grey circles), and water (represented by black squares) through HLGO membranes. Dotted lines are the best exponential fits, hexane and methanol being the upper and lower straight lines respectively, water being the curved line. The black dotted curve is a guide to the eye. Inset: Water permeance as a function of inverse thickness for HLGO membranes with thicknesses 100 nm. Dotted line: best linear fit. The solid line in the main figure shows the detection limit for methanol and hexane in our experiment.

FIG. 4 shows GO flake size distribution. (a) SEM image of GO flakes used for the preparation of CGO membranes (Scale bar, 200 nm) and (b) its flake size distribution. (c) Optical image of GO flakes used for the preparation of HLGO membranes (Scale bar, 20 μm) and (d) its flake size distribution. The flake sizes were estimated by taking the square root of the area of each flake measured with the Image J software.

FIG. 5 shows the optical detection of permeate concentration. (a) Absorption spectra of the feed and permeate solution of K₃[Fe(CN)₆] and Na₄PTS in water. (b) Absorption spectra of the feed and permeate solution of chrysoidine G (CG), disperse red (DR), methylene blue (MB), crystal violet (CV), brilliant blue (BB), and rose bengal (RB) in methanol. The absorption spectrum from an empty container was taken as a reference spectrum of all the measurements.

FIG. 6 shows the ultrathin HLGO membrane on nylon support. (a) SEM image of an 8 nm HLGO membrane on a nylon support. Scale bar, 1 μm. Inset: SEM image of a bare nylon support. Scale bar, 1 μm. (b) Ambient air XRD spectrum for HLGO membrane on nylon support. The peaks at ˜7° and 14° are from the nylon support. (c) Permeance ((represented by black filled squares)) and rejection ((represented by empty squares)) of MB in methanol through HLGO membranes with different thicknesses on nylon support. The dotted line is the best linear fit. Points between the two hashed parallel lines show the rejection estimated from the detection limit.

FIG. 7 shows vapour and gas permeation through HLGO membranes. (a) Weight loss rate for a container sealed with HLGO membranes with different thicknesses (aperture diameter≈0.5 cm). Weight loss for IPA and water were tested at room-temperature and zero humidity. (b) Thickness dependence of helium permeance through HLGO membrane. Dotted lines are the best fits to the exponential decrease. Inset: Schematics of our experimental setup for helium permeation measurement.

FIG. 8 shows the pinholes in GO membrane. (a) Schematic showing continuous interconnected GO plane formed by the random overlap of GO flakes. (b) SEM image from one of our HLGO membrane with a thickness of ≈3 nm transferred to ITO (indium tin oxide) coated glass slide showing the presence of pinholes (large pinholes are circled) in the membrane. Scale bar, 20 μm. The membrane was transferred to ITO substrate by floating the alumina supported GO membrane in water and subsequently fishing out the GO membrane onto an ITO substrate. ITO substrate was used to avoid the charging effect during SEM imaging.

FIG. 9 shows Mg²⁺ crosslinked GO membranes. (a) X-ray diffraction for pristine GO, Mg²⁺ crosslinked GO (GO-Mg²⁺) and partially reduced Mg²⁺ crosslinked GO (rGO-Mg²⁺) membranes. The thickness of membranes 200 nm. (b) Schematic showing the structure of the GO-Mg²⁺ membrane. The dotted line indicates the permeation pathway and circles indicate Mg²⁺ ions.

FIG. 10 shows permeation through 200 nm thick Mg²⁺-crosslinked GO membranes. (a) Permeance of various organic solvents through GO-Mg²⁺ and rGO-Mg²⁺ membrane as a function of their inverse viscosity. The used solvents are numbered and named on the top left. Dotted lines are the best linear fit. (b) Rejection of several dyes in methanol versus their molecular weight. The dyes used: CG, MB, CV, and RB. Inset: The corresponding permeance of methanol.

FIG. 11 shows the permeance of methanol (represented by circles) and rejection of MB (represented by squares) through GO membranes with thickness from 5-8 nm.

### DETAILED DESCRIPTION

In one illustrative example, the graphene oxide laminate membranes are made of impermeable functionalized graphene sheets that have a typical size L≈1 μm and the interlayer separation, d, sufficient to accommodate a mobile layer of water.

The solute or solutes to be removed from aqueous mixtures in the methods of the present invention may be defined in terms of their hydrated radius. Below are the hydrated radii of some exemplary ions and molecules.

TABLE 1

| | Hydrated | | Hydrated |
|---|---|---|---|
| Ion/molecule | radius (Å) | Ion/molecule | radius (Å) |
| K⁺ | 3.31 | Li⁺ | 3.82 |
| Cl⁻ | 3.32 | Rb⁺ | 3.29 |
| Na⁺ | 3.58 | Cs⁺ | 3.29 |
| CH₃COO⁻ | 3.75 | NH₄⁺ | 3.31 |
| SO₄²⁻ | 3.79 | Be²⁺ | 4.59 |
| AsO₄³⁻ | 3.85 | Ca²⁺ | 4.12 |
| CO₃²⁻ | 3.94 | Zn²⁺ | 4.30 |
| Cu²⁺ | 4.19 | Ag⁺ | 3.41 |
| Mg²⁺ | 4.28 | Cd²⁺ | 4.26 |
| propanol | 4.48 | Al³⁺ | 4.80 |
| glycerol | 4.65 | Pb²⁺ | 4.01 |
| [Fe(CN)₆]³⁻ | 4.75 | NO₃⁻ | 3.40 |
| sucrose | 5.01 | OH— | 3.00 |
| (PTS)⁴⁻ | 5.04 | H₃O⁺ | 2.80 |
| [Ru(bipy)₃]²⁺ | 5.90 | Br— | 3.30 |
| Tl⁺ | 3.30 | I— | 3.31 |
| Brilliant Blue | 8.0 | Rose Bengal | 5.9 |
| G ion | | ion | |
| Rhodamine B | 6.2 | Methyl Blue ion | 7.3 |
| Methylene | 5.0 | Orange G ion | 5.21 |
| Blue ion | | | |
| Ruthenium II | 5.9 | Raffinose | 6 |
| Lactose | 5.4 | Methyl Viologen | 4.4 |
| | | ion | |
| Methyl Red | 4.9 | Methyl | 5.0 |
| | | Orange ion | |

The hydrated radii of many species are available in the literature. However, for some species the hydrated radii may not be available. The radii of many species are described in terms of their Stokes radius and typically this information will be available where the hydrated radius is not. For example, of the above species, there exist no literature values for the hydrated radius of propanol, sucrose, glycerol and PTS⁴⁻. The hydrated radii of these species which are provided in the table above have been estimated using their Stokes/crystal radii. To this end, the hydrated radii for a selection of species in which this value was known can be plotted as a function of the Stokes radii for those species and this yields a simple linear dependence. Hydrated radii for propanol, sucrose, glycerol and PTS⁴⁻ were then estimated using the linear dependence and the known Stokes radii of those species.

There are a number of methods described in the literature for the calculation of hydration radii. Examples are provided in ‘Determination of the effective hydrodynamic radii of small molecules by viscometry’; Schultz and Soloman; The Journal of General Physiology; 44; 1189-1199 (1963); and ‘Phenomenological Theory of Ion Solvation’; E. R. Nightingale. J. Phys. Chem. 63, 1381 (1959).

The graphene oxide for use in this application can be made by any means known in the art. In a preferred method, graphite oxide can be prepared from graphite flakes (e.g. natural graphite flakes) by treating them with potassium permanganate and sodium nitrate in concentrated sulphuric acid. This method is called Hummers method. Another method is the Brodie method, which involves adding potassium chlorate (KClO₃) to a slurry of graphite in fuming nitric acid. For a review see, Dreyer et al. The chemistry of graphene oxide, Chem. Soc. Rev., 2010, 39, 228-240.

Individual graphene oxide (GO) sheets can then be exfoliated by dissolving graphite oxide in water or other polar solvents with the help of ultrasound, and bulk residues can then be removed by centrifugation and optionally a dialysis step to remove additional salts.

In a specific embodiment, the graphene oxide of which the graphene oxide laminate membranes of the invention are comprised is not formed from wormlike graphite. Worm-like graphite is graphite that has been treated with concentrated sulphuric acid and hydrogen peroxide at 1000 C to convert graphite into an expanded “worm-like” graphite. When this worm-like graphite undergoes an oxidation reaction it exhibits a higher increase in the oxidation rate and efficiency (due to a higher surface area available in expanded graphite as compared to pristine graphite) and the resultant graphene oxide contains more oxygen functional groups than graphene oxide prepared from natural graphite. Laminate membranes formed from such highly functionalized graphene oxide can be shown to have a wrinkled surface topography and lamellar structure (Sun et al; Selective Ion Penetration of Graphene Oxide Membranes; ACS Nano 7, 428 (2013) which differs from the layered structure observed in laminate membranes formed from graphene oxide prepared from natural graphite. Such membranes do not show fast ion permeation of small ions and a selectivity which is substantially unrelated to size (being due rather to interactions between solutes and the graphene oxide functional groups) compared to laminate membranes formed from graphene oxide prepared from natural graphite.

Without wishing to be bound by theory, individual GO crystallites formed from non-worm like graphite (e.g. natural or pristine graphite) may have two types of regions: functionalized (oxidized) and pristine. The former regions may act as spacers that keep adjacent crystallites apart and the pristine graphene regions may form the capillaries which afford the membranes their unique properties.

The preparation of graphene oxide supported on a porous membrane can be achieved using filtration, spray coating, casting, dip coating techniques, road coating, inject printing, or any other thin film coating techniques

For large scale production of supported graphene based membranes or sheets it is preferred to use spray coating, road coating or inject printing techniques. One benefit of spray coating is that spraying GO solution in water on to the porous support material at an elevated temperature produces a large uniform GO film.

Graphite oxide consists of micrometer thick stacked graphite oxide flakes (defined by the starting graphite flakes used for oxidation, after oxidation it gets expanded due to the attached functional groups) and can be considered as a polycrystalline material. Exfoliation of graphite oxide in water into individual graphene oxide flakes was achieved by the sonication technique followed by centrifugation at 10000 rpm to remove few layers and thick flakes. Graphene oxide laminates were formed by restacking of these single or few layer graphene oxides by a number of different techniques such as spin coating, spray coating, road coating and vacuum filtration.

Graphene oxide membranes according to the invention consist of overlapped layers of randomly oriented graphene oxide sheets. Due to the difference in layered structure, the atomic structure of the capillary structure of graphene oxide membranes and graphite oxide are different. For graphene oxide membranes the edge functional groups are located over the non-functionalised regions of another graphene oxide sheet while in graphite oxide mostly edges are aligned over another graphite oxide edge. These differences unexpectedly may influence the permeability properties of graphene oxide membranes as compared to those of graphite oxide.

Where the graphene oxide is partially reduced graphene oxide, it is preferable that a graphene oxide laminate membrane be formed first and that that membrane be subjected to a reducing agent, e.g. ascorbic acid or HI, in an appropriate amount to achieve the desired level of oxygenation.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### EXAMPLES

### Discussion

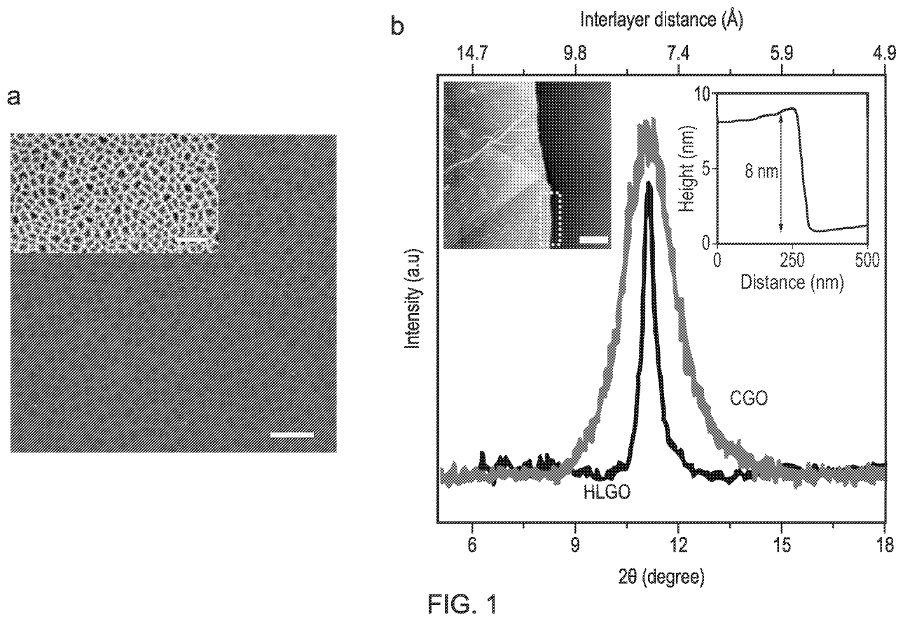

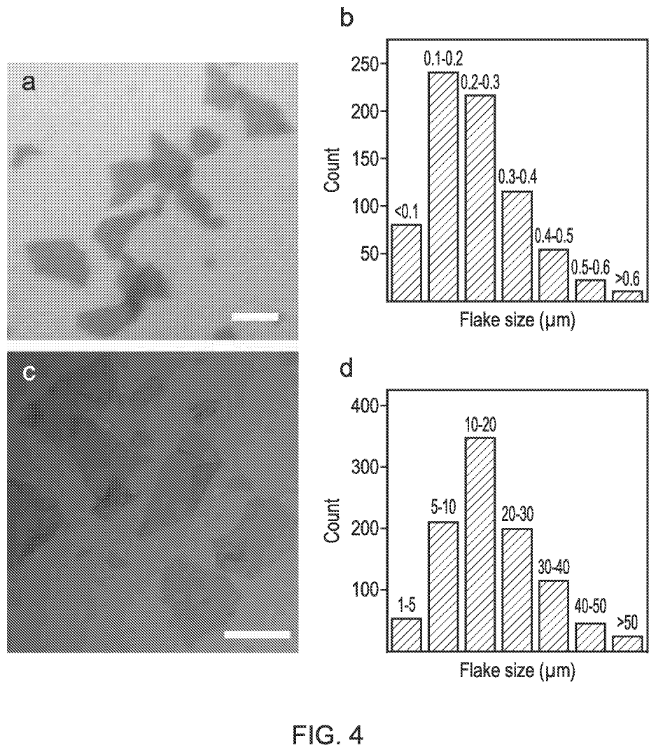

The preparation of GO membranes used in our work is described in the section titled Methods below. FIG. 1 shows the scanning electron microscope (SEM), atomic force microscope (AFM) images and X-ray diffraction (XRD) of the studied GO membranes. Short duration ultrasonic exfoliation and a stepwise separation (see Methods) were used to obtain large GO flakes (lateral size D of 10-20 μm) with a relatively narrow size distribution (FIG. 4). The membranes prepared from these large GO flakes are referred to as highly laminated GO (HLGO) membranes due to their superior laminar structure. They show a narrow XRD peak (full width at half maximum of 0.4 degree) as compared to 1.6 degree for the standard GO membranes prepared from smaller flakes (D˜0.1-0.6 μm). Below the latter are referred to as the conventional GO (CGO) membrane. The narrow X-ray peak for HLGO laminates suggests the importance of the GO flake size for the alignment process, which can be attributed to stronger interlayer interaction between larger overlapping areas.

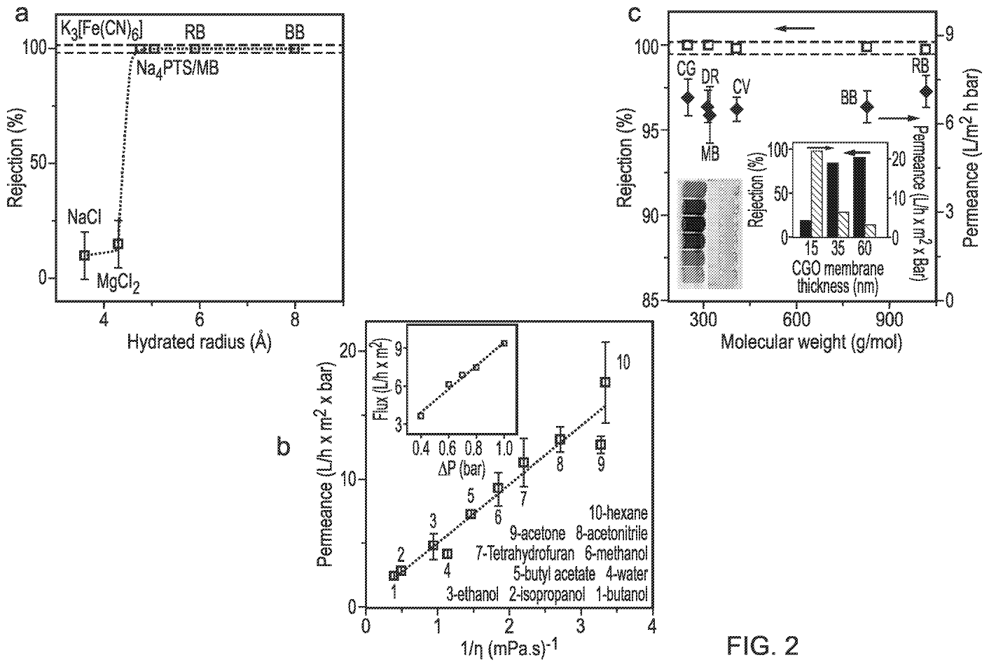

To probe molecular sieving properties of HLGO membranes, we first performed vacuum filtration of aqueous solutions of several salts and large molecules through HLGO membranes (see Methods). FIG. 2a shows the molecular sieving properties of an 8 nm thin HLGO membrane. Similar to micron-thick GO membrane, HLGO membranes also block all ions with hydrated radii larger than 4.5 Å. We emphasize that no molecular sieving was observed in similar experiments but using CGO membranes with thickness of 8-50 nm (FIG. 2a inset). Hence, the ultra-sharp sieving cut-off can be achieved in HLGO membranes that are more than two orders of magnitude thinner than conventional membranes showing same sieving properties. This drastic improvement can be attributed to the highly laminated nature of our HLGO membranes. We failed to observe a cut-off in sieving only for the membranes thinner than 8 nm, which sets a minimum thickness for HLGO membranes used in this study.

Ultrahigh permeance to fluids may occur in ultrathin membranes due to a decreased molecular permeation length. To further evaluate liquid permeance of HLGO membranes, we have performed vacuum filtration experiments with water and a wide range of organic solvents using only 8 nm thick membranes. All the permeance values were recorded after reaching a steady state condition, typically achieved within 30 minutes. The liquid flux is found to be linearly proportional the differential pressure (ΔP) across an HLGO membrane (FIG. 2b inset). The permeance for various solvents as a function of their inverse viscosity (1/η) is shown in FIG. 2b. In contrast to much-thicker GO membranes that exhibit ultrafast water permeation and impermeability for organic solvents, our HLGO membranes are highly permeable to all tested solvents. The highest permeance is observed for solvents with the lowest viscosity. For example, hexane shows permeance of ˜18 Lm⁻² h⁻¹ bar⁻¹ despite the fact that its kinetic diameter is almost twice larger than that of water. On the contrary, 1-butanol with a kinetic diameter similar to that of hexane but much higher viscosity exhibits the lowest permeance of 2.5 Lm⁻² h⁻¹ bar⁻¹. The linear dependence of permeance on 1/η (see FIG. 2b) clearly indicates that the solvent viscosity dictates its permeability and proves the viscous nature of the solvents' flow through HLGO membranes.

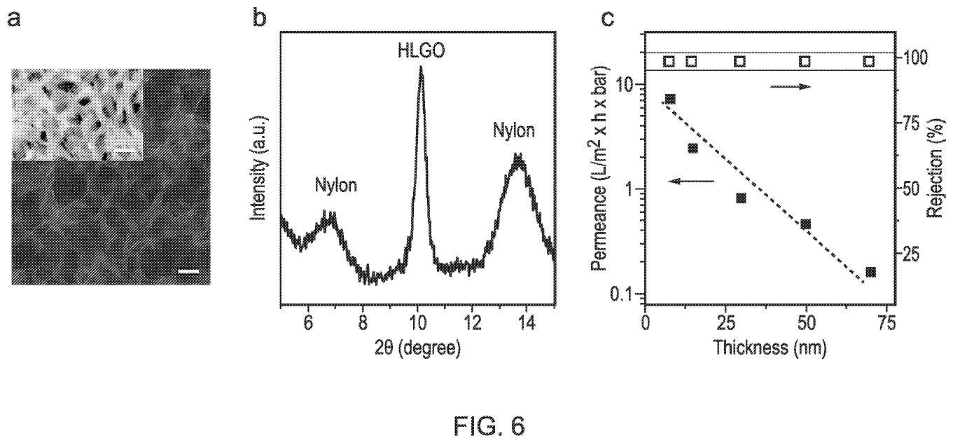

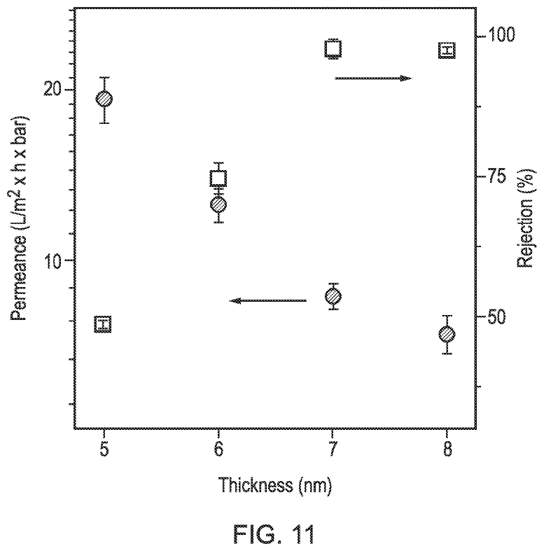

High permeance of organic solvents combined with accurate molecular sieving makes ultrathin HLGO membranes attractive for OSN. To evaluate this potential for applications, we have performed filtration experiments with methanol solutions of several dye molecules. The dye molecule rejection rates for an 8 nm thick HLGO membrane are presented in FIG. 2c. While the permeance was reduced by ˜10-30% compared to the pure solvent (which is not unusual for nanofiltration), no dye molecule could be detected down to 0.1% (our detection limit) of the feed concentration at the permeate side (FIG. 2b). The observed ˜100% dye rejection and fast solvent permeation makes our ultrathin HLGO membranes superior to the state-of-the-art polymeric membranes. For example, the highest methanol permeance reported on polymeric membranes is ˜1.6 Lm⁻² h⁻¹ bar⁻¹ for 90% Rose Bengal (RB) rejection which is ≈5 times lower than the methanol permeance obtained with our HLGO membranes providing ≈100% RB rejection. With the view of practical applications, we have also performed OSN experiments with HLGO deposited on porous polymer (nylon) support (see Methods section 2.1 below). The nylon supported HLGO membranes showed nearly the same performance as those on the alumina support. For example, an 8 nm HLGO membrane on nylon showed a >99.9% rejection to Methylene Blue (MB) with ≈7 Lm⁻² h⁻¹ bar⁻¹ methanol permeance (FIG. 6). Some rejection of methylene blue was even observed in membranes as thin as 5 nm (FIG. 11).

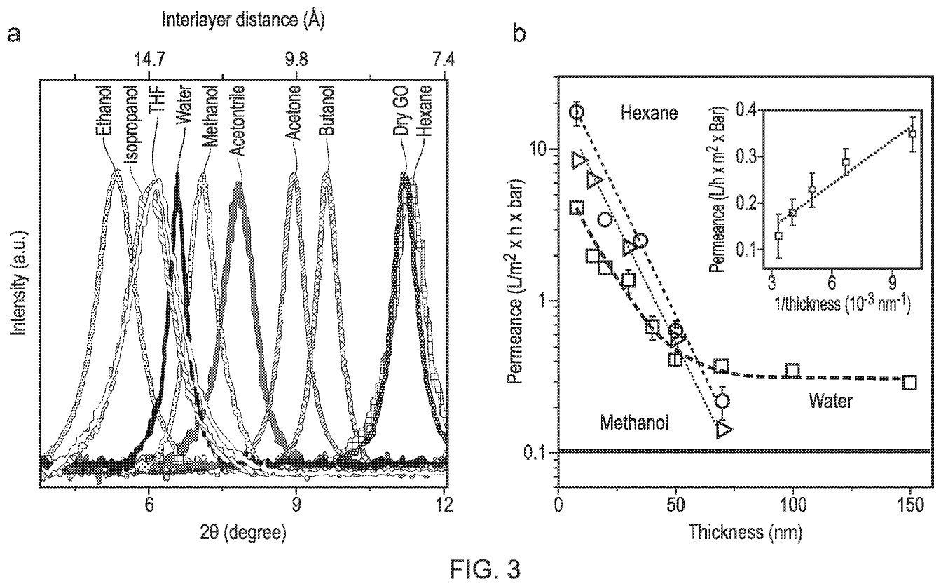

To elucidate the mechanism of organic-solvent permeation and sieving properties of ultrathin HLGO membranes, we have conducted two sets of additional experiments. First, we have performed XRD for HLGO membranes immersed in different organic solvents, see FIG. 3a. The data clearly indicate that several of the organic solvents, especially polar ones, intercalate between graphene oxide layers and increase the interlayer distance, d. However, non-polar solvents, such as hexane, did not produce any increase in d. At the same time, hexane was the fastest permeating molecule among the solvents used in this study (FIG. 2b). This suggests that permeation through ultrathin HLGO membranes is not dominated by molecular transport through interlayer capillaries. Second, we performed water and organic solvent permeation experiments using HLGO membranes of different thicknesses, h. FIG. 3b shows the exponential decay for methanol and hexane permeance as a function of h. HLGO membranes with h>70 nm show no detectable solvent permeation, consistent with the impermeability reported for sub-micron thick GO membranes. Using helium and organic vapours, we also observed a similar, exponential decay with increasing h of our HLGO membranes (see Method section 2.2 below). In contrast, water permeance initially decayed exponentially, too, but for h>70 nm it followed a much weaker, linear dependence on 1/h (FIG. 3b inset).

The exponential decrease of organic-solvent permeance with h is surprising and seemingly contradicts to the viscous flow inferred from the observed 1/η dependence. Indeed, the viscous flow suggests that the permeance should be proportional to the pressure gradient ΔP/L, where ΔP is the driving pressure gradient and L is the permeation length (proportional h). For example, the linear dependence of water permeance on 1/h for the thicker membrane is consistent with the viscous flow. To explain these two functional dependences, we propose two different molecular pathways for permeation through HLGO membranes. The first involves permeation through pin holes (pathway 1) and the second one is through the previously suggested model of a network of graphene capillaries (pathway 2).

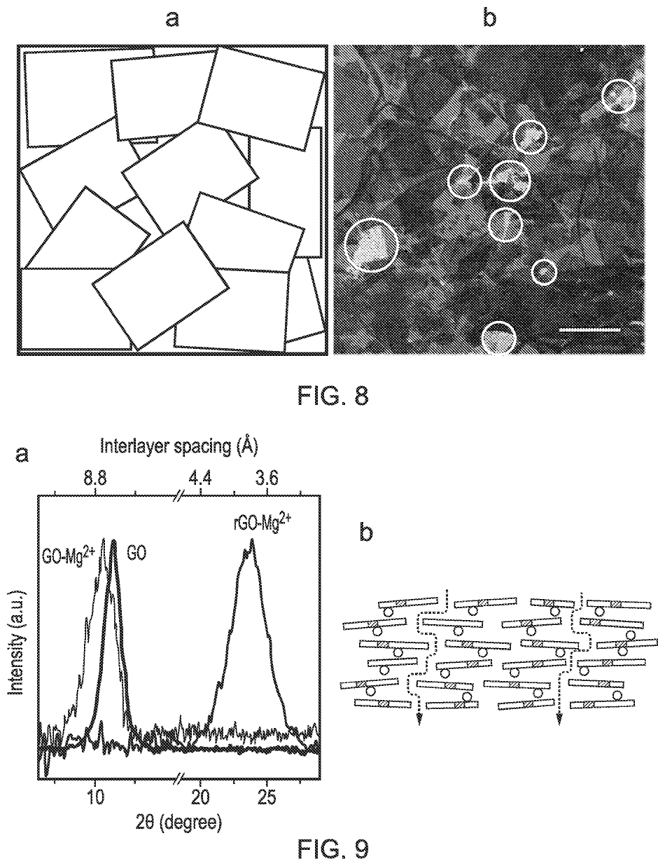

Pin holes in GO membranes originate from random stacking of individual GO flakes and can also involve nanometre size holes within flakes. At a few nm thicknesses, GO laminates contain many pinholes (FIG. 8) that pierce through the entire film. Such thin GO films allow relatively easy permeation through pinholes without any atomic-size cutoff observed for thicker laminates. At a certain critical thickness h_{c}, GO films become continuous with all pinholes blocked, as the found onset of atomic-scale sieving indicates. The experiment shows that for HLGO membranes, h_{c} is ˜8 nm. After this threshold, molecular transport is expected to occur in two steps. Liquids continue to rapidly fill the same pinholes but this is not a limiting process. Molecular transport through the entire film becomes limited by the necessity to reach from one pinhole to another, which involves in-plane diffusion between GO sheets. This bottleneck has to involve interlayer diffusion by a distance of the order of the size of GO sheets, which will provide an atomic-scale sieve size for filtration. Assuming that a probability for a molecule to find a pathway through the thinnest continuous membrane with critical thickness h_{c} is p, we can write the probability of transport through a thicker sheet of thickness h as P=p^{N} where N=h/h_{c}. This can be re-written as P=exp[ln(p)h/h_{c}] and yields the flux Q ∝exp(−h/a) with a=h_{c}/ln(1/p). By definition p should be of the order of ½ because we define it at the threshold, which means that p⇒1 for h<h_{c} and p⇒0 for thicker layers. Therefore, a=h_{c}/ln(1/p)˜h_{c}, in agreement with exponential fit in FIG. 3b. This proposed model could also explain why the molecular sieve size of ≈4.5 Å is not preserved in thin CGO membranes where the smaller flake size increased the critical thickness and weakened the interlayer alignment.

The deviation of water permeance from the exponential decay and it's faster transport at large h can be understood by considering the molecular pathway 2 where the permeation occurs through the graphene capillaries. The permeation through the pathway 2 is primarily restricted by the hydraulic resistance due to a large L (D/d×h). However, water permeation through these capillaries experiences three orders of magnitude enhanced flow due to the large slip length and therefore effectively reduces the flow resistance. This suggests that with increasing h, the exponentially growing flow resistance for water in the pathway 1 could be overcome by the lower flow resistance in the pathway 2 due to the large slip length, consistent with the deviation from the exponential decay observed above ˜50 nm in FIG. 3b. The linear dependence of water permeance on 1/h for the HLGO membranes with a thickness larger than 70 nm (FIG. 3b inset) further proves that the flow through the thicker membranes predominantly occurs through the graphene capillaries. In contrast, for organic solvents, the experimentally undetectable permeation for h>70 nm indicate that the permeation through the pathway 2 is negligible and suggests a non-slip flow. This is not surprising because graphitic surfaces are known for their lipophilicity, that is, they interact strongly with hydrocarbons. This is consistent with the recent calculation of larger interfacial friction for ethanol in graphene capillaries compared to water. The non-slip behavior of organic solvents also explains why certain organic molecules (polar solvents) can uniformly intercalate between GO layers, similar to water, but their permeability remains below our detection limit.

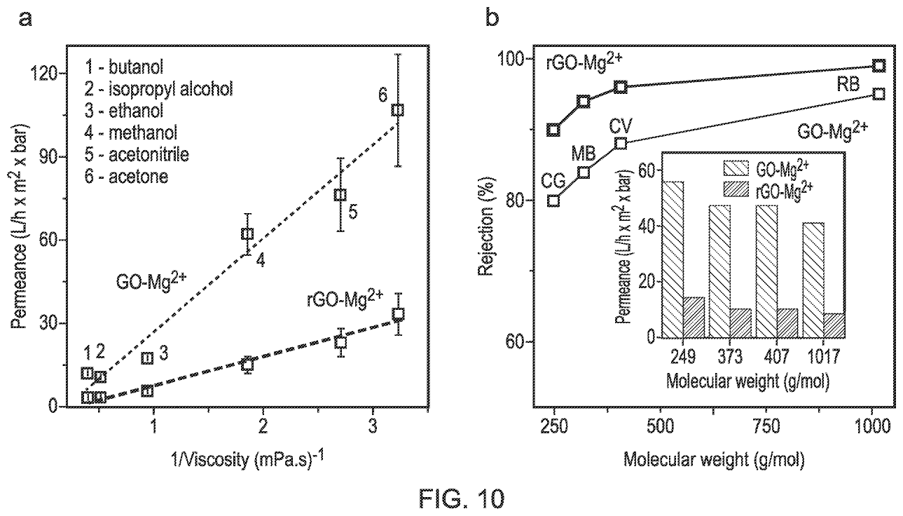

Based on the understanding of organic molecule permeation through GO membranes, we propose a strategy to further improve the permeance through GO membranes without substantially reducing the organic solute rejection, even using relatively thick membranes. To this end, we used partially reduced Mg²⁺ crosslinked GO membrane with 200 nm thickness, where the randomly distributed Mg²⁺ ions between GO sheets play a role of spacers that introduces the disorder in the laminar structure and hence increases the permeance (FIG. 9 and Method section 2.4 below). These modified membranes show ˜50% increase in permeance while keeping the dye rejection at 98% (FIG. 10).

In conclusion, we show that HLGO membranes of only several layers in thickness exhibit outstanding sieving properties accompanied by ultrafast solvent permeation. Taking into account the excellent chemical stability of GO, the reported membrane can be used for organic solvent nanofiltration, with pharmaceutical and petrochemical industries being potential beneficiaries. The proposed strategy to enhance the nanofiltration properties of GO membranes by cation-crosslinking is also attractive.

### Methods

### 1.1 Preparation of GO Membranes:

Graphite oxide was prepared by the Hummers method and then dispersed in water by sonication, which resulted in stable GO solutions. GO membranes were prepared by vacuum filtering aqueous GO solutions through Anodisc Alumina or Nylon membrane (47 mm diameter Whatman filters with 200 nm pore size). To obtain a uniform membrane, the GO suspension was diluted to less than 0.001 wt % before the vacuum filtration. After filtration, the membrane was allowed to dry under vacuum at room temperature for at least 24 hours before the measurements.

Two types of GO membranes used in this study are HLGO and CGO membranes. The difference between preparation of HLGO and CGO membrane lies in the ultrasonic exfoliation and centrifugal separation process. For HLGO membranes, the graphite oxide was exfoliated by a 3-minute ultrasonic exfoliation (40 W power) and then subsequently centrifuged twice at 3000 rpm for 10 minutes to separate un-exfoliated thick GO flakes. The supernatant GO solution was further centrifuged at 12000 rpm to separate large and small GO flakes. In this step, the sediment was collected because the small size and hence lighter GO flakes remain in the supernatant and larger GO flakes sediments. This sediment was then collected and re-dispersed in water by mild shaking and then repeated the centrifugation steps at 10000 and 8000 rpm respectively. This repeated centrifugation cycles with sequentially decreasing centrifugation speed enable the separation of medium size GO flakes from the large flakes and allows obtaining uniform large GO flakes required for the preparation of HLGO membranes. For the preparation of CGO membranes, the graphite oxide in water was sonicated for 24 hours and then centrifuged three times at 8000 rpm. The supernatant was then collected and used for the membrane preparation.

The flake size distribution of GO used for the preparation of conventional CGO and HLGO membranes were measured by analysing more than 700 flakes with the scanning electron microscopy (SEM) or optical microscopy. Due to long time ultrasonication, all the GO flakes used for the CGO membranes are found to be smaller than 1 μm in nominal size and more than 75% of these flakes are with a size between 0.1-0.4 μm. In comparison, for HLGO membranes, 75% of the flakes used were found to be larger than 10 μm (FIG. 4).

### 1.2 Membrane Characterizations:

SEM and AFM techniques were used to measure the size of GO flakes and thickness of the membranes. A Veeco Dimension 3100AFM in the tapping mode was used for the AFM measurements. To measure the thickness of the GO membranes, we transferred the membrane from the alumina support to a silicon substrate by floating the alumina supported GO membrane in water and subsequently fishing out the GO membrane onto a silicon substrate. GO membrane transferred silicon substrates were completely dried in vacuum before the AFM measurements.

X-ray diffraction measurements in the 2θ range of 5° to 25° (with a step size of 0.02° and recording rate of 0.2 s) were performed using a Bruker D8 diffractometer with Cu Kα radiation (λ=1.5406 Å). Due to the weak intensity of the X-ray peak from an 8 nm membrane we used 70 nm thick membranes for our experiments. To collect an XRD spectrum from HLGO membranes exposed to different organic solvents, the membranes were first aged in a glovebox filled with dry argon gas for more than 5 days to remove any interlayer water present in the membranes and then immersed in various solvents for more than 3 days inside a glove box. For the XRD measurements, the samples were collected from the solvents and kept inside an airtight XRD sample holder (Bruker, A100B36/B37) filled with same organic solvent vapour to avoid any influences of the environmental humidity and evaporation of solvent from the membrane on the measurements.

### 1.3 Permeation and Molecular Sieving Measurements:

For probing the molecular sieving and solvent permeation through various GO membranes we used a vacuum filtration setup, where the membrane is clamped and sealed with a silicone rubber O-ring between the feed and permeate side. Permeate side was connected to a vacuum pump with a controllable pumping speed and a cold trap. The vacuum on the permeate side creates a pressure gradient (ΔP) which drives the molecular permeation across the membrane. For studying the influence of ΔP on the permeance, we have performed filtration experiments with different ΔP created using different pumping speed. The permeance of various solvents was obtained by measuring both the volume and weight of the solvent from the permeate side in a liquid nitrogen cold trap and the liquid leftover in the feed side. The system leakage was examined by replacing the membrane with a 100 μm polyethylene terephthalate plastic sheet, or a 200 μm Cu foil, the leakage was found to be <0.1 Lm⁻² h⁻¹ bar⁻¹.

We have noticed that for water due to its high surface tension the HLGO membrane breaks once the water was in contact with the membrane. We, therefore, used a small amount of surfactant (0.6 mg/mL sodium dodecyl benzene sulfonate) to decrease the surface tension of water and thereby avoiding the membrane damage during water permeation experiments.

For probing the molecular sieving property of HLGO and CGO membranes we used aqueous solutions of NaCl, MgCl₂, K₃[Fe(CN)₆], pyrenetetrasulfonic acid tetrasodium salt (Na₄PTS), MB, RB, and Brilliant Blue (BB). For MB, RB, and BB the feed concentrations were 20 mg/L, and for K₃[Fe(CN)₆] and Na₄PTS, their concentrations were 1000, 250 mg/L, respectively. For NaCl and MgCl₂ we used 1M concentration. All the experiments were repeated at least three times. The amount of sodium and magnesium salts permeated were measured by probing the concentration of salt in the permeate side by checking the conductivity of the permeate water. Furthermore, we cross-checked the results of our conductivity analysis by weighing the dry material left after evaporation of water in the permeate. The permeation of other salts and dyes through GO membranes was measured by checking their concentration at the permeate side by UV-vis absorption as detailed below. The salt rejection was calculated as (1-C_{P}/C_{F}), where Cₚ is the salt concentration at the permeate side and C_{F} is the salt concentration at the feed side.

For organic solution nanofiltration experiments, Chrysoidine G (CG), Methylene Blue (MB), Disperse Red (DR), Crystal Violet (CV), Brilliant Blue (BB), and Roes Bengal (RB) with a concentration of 200 mg/L were dissolved in methanol. The concentration of the dye at the permeate side was measured by UV-vis absorption as detailed below and the permeance was determined by the same method for the measurement of pure solvent as detailed above.

### 1.4 UV-Vis Absorption:

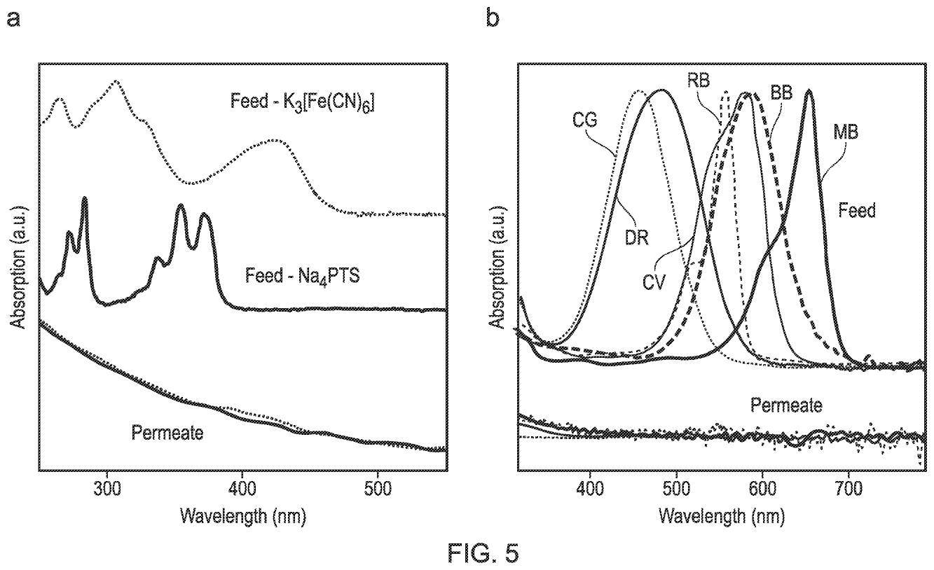

For obtaining the concentrations of K₃[Fe(CN)₆], Na₄PTS and organic dye molecules in the permeate we used optical absorption spectroscopy. UV-visible-near-infrared grating spectrometer with a xenon lamp source (240-1700 nm) was used for this study. For the HLGO membranes, we could not detect any absorption features of the above salts or dye in the permeate side (FIG. 5). To cross check this further, we have also measured the concentration of the leftover feed solution after the filtration experiment. The leftover concentrated feed solutions (including the salt or dye absorbed on the membrane) were diluted to the same volume as before the filtration experiment and then the optical absorption features were compared with the pristine original feed solution. We could not find any difference in the absorption spectra, suggesting all the solutes were retained at the feed side. The detection limit in FIGS. 2a and c were estimated by measuring a reference solution and gradually decreasing its concentration until the signature peaks completely disappeared. The penultimate concentration is set as the corresponding detection limit. For the case of CGO membranes and Mg²⁺-crosslinked membranes (FIG. 2a, 2c, and FIG. 10), the absorbance for the most intense optical absorption peak for various known concentrations of salt and dye molecules were plotted against their concentration and obtained a linear fit. From this linear dependence, we estimated the concentration of salt and dye at the permeate side.

### 2.1 HLGO Membrane on Porous Nylon Support

In addition to the porous alumina support, which is brittle, we have also tested porous polymer as a support material. It has been reported that due to the roughness and non-uniform macroscopic pore distribution of polymer support, tens of nanometre thin GO membrane (small GO flakes) fails to maintain a good laminar structure1. Here, we show that GO membrane prepared from large GO flakes could form a good laminate even if the membrane is ultrathin. FIG. 6 shows the SEM image of a bare nylon support and an 8 nm HLGO membrane deposited nylon support. X-ray diffraction (XRD) spectrum of a 50 nm HLGO membrane on nylon substrate shows a narrow peak with a full width at half maximum (FWHM) of 0.4 degree (FIG. 6b), which confirms the highly laminated structure similar to that on the alumina support. To evaluate the organic solution nanofiltration (OSN), we have tested filtration of methanol solutions of CG and MB through an 8 nm thin HLGO membrane on nylon support. Similar to that of alumina support, HLGO membrane on nylon support also shows a 99.9% rejection to CG and MB with a similar methanol permeance to that of alumina support (FIG. 6c). Also, the exponential decay of the methanol permeance (FIG. 6c) with increasing the thickness of HLGO membrane is consistent with that of the alumina supported HLGO membranes (FIG. 3b).

### 2.2 Vapour and Helium Gas Permeation Through HLGO Membranes

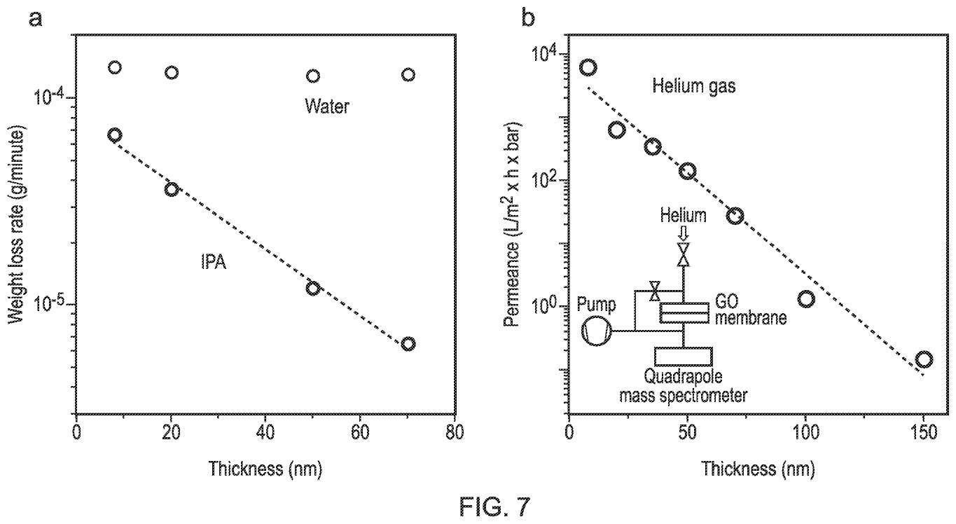

Besides liquid permeation, vapour and gas (helium) permeation through HLGO membranes with different thicknesses (h) were measured to further validate the proposed mechanism for molecular transport in GO membranes. The vapour permeation measurements were performed as we reported previously. Membranes were glued to a Cu foil with an opening of 0.5 cm in diameter. The foil was then clamped between two rubber O-rings sealing a metal container. Permeation was measured by monitoring the weight loss (for 12 hours) of the container that was filled with water and isopropyl alcohol (IPA) inside a glovebox. FIG. 7a shows the weight loss rate for water and IPA through HLGO membranes with different thicknesses. Weight loss rate for IPA was found to decay exponentially with increasing membrane thickness, indicating exponentially decaying permeance, consistent with the mechanism proposed (permeation through pinholes) earlier. However, for water, we observed a thickness independent weight loss rate. In this case, unlike liquid permeation reported in the main text, water vapour permeation is limited by the evaporation from the top surface of GO membranes and hence masks the thickness dependence.

For the helium (He) gas permeation experiments, HLGO membranes attached to the Cu foil were placed between two rubber O-rings in a custom made permeation cell and pressurised from one side up to 100 mBar. He gas permeation through the HLGO membrane was monitored on the opposite (vacuum) side by using mass spectrometry (FIG. 7b inset). We used Hiden quadrupole residual gas analyser for measuring the partial pressure of He gas in the vacuum side. A standard calibrated leak (Open style CalMaster Leak Standard, LACO technologies) is utilised to convert the partial pressure to the leak rate. FIG. 7b shows the He permeance through HLGO membrane as a function of membrane thickness. Similar to the organic solvent and vapour permeation (FIG. 3b and FIG. 7a), He gas also follows exponential decay indicating the pathway for the gas permeation is dominated by the pinholes. The observed exponential decay of He permeance with increasing thickness is consistent with the earlier study on He and H2 permeance through ultrathin GO membranes4, but the mechanism of exponential dependence was not elucidated. The proposed mechanism in this study (main text) clarifies this ambiguity.

### 2.3 Pinholes in Ultrathin HLGO Membranes

During the self-assembly of GO membrane, the flakes randomly overlap and provide a continuous interconnected plane that contains a large number of holes (FIG. 8). These holes between different flakes are referred as pinholes. Our SEM analysis shows that for ≈3 nm membranes the size of these pinholes is of the order of the flake size. With increasing numbers of layers of GO, the newly added layers block these pinholes and form fully continuous GO membranes. Our sieving experiments (FIG. 1 and FIG. 11) suggest that the minimum thickness required for the fully continuous GO membrane is ˜5 nm.

### 2.4 Mg²⁺-Crosslinked Partially Reduced GO Membrane for OSN

Multivalent cations have previously been used to crosslink the GO sheets by attaching them to the oxidised regions to improve the mechanical strength and to control the ion permeation through the GO membranes. Here, we propose the same crosslinking technique to enhance the solvent permeance through the GO membranes because the interlayer cations could act as randomly distributed external spacers to introduce disorder in the laminar structure (FIG. 9) and hence increase the permeance. We chose Mg²⁺ for crosslinking due to its large hydrated diameter, which is comparable to the interlayer spacing in GO membrane.

GO crosslinking with Mg²⁺ was carried out by the drop-by-drop addition of 10 mL of 9.5 g/L MgCl₂ into 40 mL GO suspension (0.2 wt. %) under vigorous magnetic stirring followed by at least one day of sonication. After the sonication, the suspensions were stable up to one hour (average flake size ≈200 nm) without any stirring, but it starts agglomerating after that. This could be due to the neutralisation of the negative surface charges of GO with the cations. To avoid the agglomeration we stored the suspension under vigorous stirring. Mg²⁺ crosslinked GO membranes (GO-Mg²⁺) were then prepared by the vacuum filtration of these suspensions through an Anodisc alumina membrane (200 nm pore size). The incorporation of Mg²⁺ in the GO membranes was confirmed by XRD analysis, where a broader GO peak was found (FIG. 9a). An increase of FWHM from 1.6 degree to 2.1 degree indicates a poor interlayer alignment in GO-Mg²⁺ (FIG. 9b) compared to pristine GO and suggests the prospect of obtaining higher permeance. The organic solvents permeance and organic solution nanofiltration (OSN) through GO-Mg²⁺ membranes (200 nm thick) were measured by vacuum filtration technique as detailed in the main text. FIG. 10 shows the pure solvent permeance and dye rejection properties of GO-Mg²⁺ membranes. Comparing to the performance of the CGO membranes, even though GO-Mg²⁺ membranes are thicker, they show nearly one order of magnitude higher permeance to methanol but with same dye rejection (84% MB rejection for 35 nm CGO and 200 nm GO-Mg²⁺ membrane) (FIG. 10b and FIG. 2c inset). The enhanced permeance through GO-Mg²⁺ membranes suggests that the addition of Mg²⁺ increases the disorder in the laminar structure as shown in FIG. 9b.

To further improve the dye rejection performance of the GO-Mg²⁺ membranes, we partially reduced them in hydroiodic acid vapour for 1 min at room temperature. The partially reduced GO-Mg2+ membranes (rGO-Mg²⁺ membranes) show a broad XRD peak at ≈23.7° (FIG. 9), suggesting the collapse of the interlayer channels. However, in comparison to the fully reduced GO membranes (peak at ≈25° with FWHM of 1.7 degree), where it blocks the permeation of all gases and solvents, the larger FWHM of 3.3 degree confirms larger disorder in the laminar structure which could allow the molecular permeation. Our filtration experiments further support this. After the partial reduction, even though the permeance of all the solvents decreased by a factor of ≈3.5 (FIG. 10a), it is still 30-50% higher than even the permeance for an 8 nm thick HLGO membranes. Besides, the rGO-Mg²⁺ membranes exhibited 90-99% rejections to the organic dye molecules with molecular weights ranging from 249 g/mol to 1017 g/mol (FIG. 10b). We explain the relatively lower permeance and high rejection of dye molecules for rGO-Mg²⁺ membranes compared to GO-Mg²⁺ membranes by the close packing of the interlayer after the reduction, which could make the disordered interlayer channels narrower. Even though further improvement in membrane performance could be achieved with better optimisations in the membrane crosslinking process, our findings show the potential of crosslinked GO membrane for organic solution nanofiltration applications.

1. A graphene oxide laminate membrane, comprising
a plurality of graphene oxide flakes having a size distribution such that greater than 75% of the flakes have a shortest lateral dimension that is greater than 3 μm,
wherein the graphene oxide laminate membrane is no more than 80 nm thick.

2. The graphene oxide laminate membrane of claim 1, wherein the graphene oxide laminate membrane is from 5 nm to 15 nm thick.

3. The graphene oxide laminate membrane of claim 1, wherein the graphene oxide flakes have an average oxygen:carbon weight ratio in a range of from 0.2:1.0 to 0.5:1.0.

4. The graphene oxide laminate membrane of claim 1, wherein the graphene oxide flakes have a size distribution such that greater than 75% of the flakes have a longest lateral dimension that is less than 100 μm.

5. The graphene oxide laminate membrane of claim 1 which comprises overlapped layers of the graphene oxide flakes, wherein a full width of half maximum of an X-ray diffraction peak for interlayer spacing of the graphene oxide laminate membrane is between 0.1 and 2 degrees.

6. The graphene oxide laminate membrane of claim 1, wherein the graphene oxide laminate membrane comprises at least 75% by weight graphene oxide.

7. The graphene oxide laminate membrane of claim 1 which comprises at least 75% by weight of graphene oxide that is present in monolayer graphene oxide flakes.

8. The graphene oxide laminate membrane of claim 1 which is comprised in a composite with a porous support.

9. A graphene oxide laminate membrane, comprising a plurality of graphene oxide flakes; and a plurality of metal cations intercalated between the graphene oxide flakes,
wherein the graphene oxide laminate membrane is no more than 5 μm thick.

10. The graphene oxide laminate membrane of claim 9, wherein the graphene oxide laminate membrane is from 100 nm to 500 nm thick.

11. The graphene oxide laminate membrane of claim 9, wherein the graphene oxide flakes have an average oxygen:carbon weight ratio in a range of from 0.01:1.0 to 0.5:1.0.

12. The graphene oxide laminate membrane of claim 11, wherein the graphene oxide flakes have an average oxygen:carbon weight ratio in a range of from 0.04:1.0 to 0.25:1.0.

13. The graphene oxide laminate membrane of claim 9, wherein the plurality of graphene oxide flakes have a size distribution such that greater than 75% of the flakes have a longest lateral dimension that is less than 1 μm.

14. The graphene oxide laminate membrane of claim 9, which comprises at least 75% by weight of graphene oxide that is present in monolayer graphene oxide flakes.

15. The graphene oxide laminate membrane of claim 9, which is comprised in a composite with a porous support.

16. The graphene oxide laminate membrane of claim 1 which is comprised in a liquid filtration device.

17. A method of reducing an amount of at least one solute in an organic solution to produce a product solution depleted in said solute or solutes and/or of excluding an amount of at least one solute from the organic solution to produce a residue comprising the excluded solute or solutes, the method comprising:
(a) contacting a first face of a graphene oxide laminate membrane with the organic solution comprising the solute or solutes; and
(b) recovering the product solution from or downstream from a second face of the graphene oxide laminate membrane and/or recovering the residue comprising the excluded solute or solutes from or downstream from the first face of the graphene oxide laminate membrane,
wherein the graphene oxide laminate membrane comprises a plurality of graphene oxide flakes, and
wherein the graphene oxide laminate membrane is no more than 80 nm thick.

18. The method of claim 17, wherein:
(a) the graphene oxide laminate membrane comprises a plurality of graphene oxide flakes having a size distribution such that greater than 75% of the flakes have a shortest lateral dimension that is greater than 3 μm,
(b) the plurality of graphene oxide flakes have a size distribution such that greater than 75% of the flakes have a shortest lateral dimension that is greater than 3 μm,
(c) the graphene oxide laminate membrane is from 5 nm to 15 nm thick,
(d) the graphene oxide flakes have an average oxygen:carbon weight ratio in a range of from 0.2:1.0 to 0.5:1.0,
(e) the graphene oxide flakes have a size distribution such that greater than 75% of the flakes have a longest lateral dimension that is less than 100 μm,
(f) the graphene oxide laminate membrane comprises overlapped layers of the graphene oxide flakes, wherein a full width of half maximum of an X-ray diffraction peak for interlayer spacing of the graphene oxide laminate membrane is between 0.1 and 2 degrees,
(g) the graphene oxide laminate membrane comprises at least 75% by weight graphene oxide,
(h) the graphene oxide laminate membrane comprises at least 75% by weight of graphene oxide that is present in monolayer graphene oxide flakes, or
(i) the graphene oxide laminate membrane is comprised in a composite with a porous support.

19. A method of reducing an amount of at least one solute in an organic solution to produce a product solution depleted in said solute or solutes and/or of excluding an amount of at least one solute from the organic solution to produce a residue comprising the excluded solute or solutes, the method comprising:
(a) contacting a first face of a graphene oxide laminate membrane with the organic solution comprising the solute or solutes; and
(b) recovering the product solution from or downstream from a second face of the graphene oxide laminate membrane and/or recovering the residue comprising the excluded solute or solutes from or downstream from the first face of the graphene oxide laminate membrane,
wherein the graphene oxide laminate membrane comprises a plurality of graphene oxide flakes and, intercalated between the graphene oxide flakes, a plurality of metal cations.

20. The method of claim 19, wherein:
(a) the graphene oxide laminate membrane is no more than 5 μm thick,
(b) the graphene oxide laminate membrane is from 100 nm to 500 nm thick,
(c) the graphene oxide flakes have an average oxygen:carbon weight ratio in a range of from 0.01:1.0 to 0.5:1.0,
(d) the graphene oxide flakes have an average oxygen:carbon weight ratio in a range of from 0.04:1.0 to 0.25:1.0,
(e) the plurality of graphene oxide flakes have a size distribution such that greater than 75% of the flakes have a longest lateral dimension that is less than 1 μm,
(f) the graphene oxide laminate membrane comprises at least 75% by weight of graphene oxide that is present in monolayer graphene oxide flakes, or
(g) the graphene oxide laminate membrane is comprised in a composite with a porous support.

21. The method of claim 17, wherein the organic solution comprises an organic solvent selected from methanol, ethanol, isopropanol, 1-butanol, tert-butanol, ethylene glycol, hexane, pentane, heptane, cyclohexane, dimethylethylene glycol, diethyl ether, t-butylmethyl ether, tetrahydrofuran, dioxane, acetone, t-butylmethylketone, N-methylpyrrolidine, dimethylformamide, dimethylacetamide, dimethylsulfoxide, benzene, toluene, ethyl acetate butyl acetate, acetonitrile, chloroform, dichloromethane, 1,2-dichloroethane and mixtures thereof.

22. The method of claim 17, wherein:
(a) a concentration of the excluded solute or solutes in the product organic solution is reduced by 90% or more relative to the concentration of the excluded solute or solutes in the starting organic solution,
(b) the excluded solute or solutes have a hydration radius greater than 4.5 Å, or
(c) the method comprises recovering the residue comprising the excluded solute or solutes from the first face of the graphene oxide laminate membrane.

23-31. (canceled)

32. The method of claim 19, wherein the organic solution comprises an organic solvent selected from methanol, ethanol, isopropanol, 1-butanol, tert-butanol, ethylene glycol, hexane, pentane, heptane, cyclohexane, dimethylethylene glycol, diethyl ether, t-butylmethyl ether, tetrahydrofuran, dioxane, acetone, t-butylmethylketone, N-methylpyrrolidine, dimethylformamide, dimethylacetamide, dimethylsulfoxide, benzene, toluene, ethyl acetate butyl acetate, acetonitrile, chloroform, dichloromethane, 1,2-dichloroethane and mixtures thereof.

33. The method of claim 19, wherein:
(a) a concentration of the excluded solute or solutes in the product organic solution is reduced by 90% or more relative to the concentration of the excluded solute or solutes in the starting organic solution,
(b) the excluded solute or solutes have a hydration radius greater than 4.5 Å, or
(c) the method comprises recovering the residue comprising the excluded solute or solutes from the first face of the graphene oxide laminate membrane.
